(19) United States
(12) Patent Application Publication
(10) Pub. No.: US 2018/0093370 A1
(43) Pub. Date: Apr. 5, 2018

(54) Fastening Tool with Contact Arm and Multi-Fastener Guide

(71) Applicant: Stanley Black & Decker, Inc., New Britain, CT (US)

(72) Inventors: Daniel Yip, Changhua (TW); Rachel Lai, Changhua (TW)

(21) Appl. No.: 15/285,066

(22) Filed: Oct. 4, 2016

(51) Int. Cl. B25C 1/00; F16B 15/08; B25C 1/06; B25C 5/15

(52) U.S. Cl. CPC B25C 1/008; B25C 5/15; B25C 1/06; F16B 15/08

(57) ABSTRACT

A fastening tool includes a contact arm system for actuating an electrical switch, the contact arm system including an elongated member having a tool alignment slide disposed at one end, and a coil spring at the other. When the fastening tool is pressed against a work surface, the tool alignment slide moves the elongated member toward the electrical switch so that the coil spring causes a switch operator to close the switch. The fastening tool also includes a fastener guide system which pivots two parallel guide fingers simultaneously into the drive path of the fastener driver, so that one or both guide fingers may engage respective legs of three different kinds of staples, as well as brads and headless pins. The contact arm and fastener guide systems are compact and ideal for use in the space-sensitive environments of, for example, a tacker and a hand stapler.

### BACKGROUND OF THE INVENTION

### 1. Field of the Invention

The present invention relates to fastening tools, and more particularly to fastening tools having contact arms for actuating an electrical switch, and also having guide systems for guiding fasteners along a drive path.

### 2. Description of the Related Art

Some types of fastening tools, such as nailers and staplers, are provided with contact trips operatively associated with an electrical switch in circuit with the drive system of the tool. When the contact trip is pressed against a work surface, the contact trip closes the switch, thereby enabling an operator to fire the tool. If the contact trip is not pressed against a work surface, the tool cannot fire, even if the trigger switch is engaged. However, conventional contact trip systems are complicated and often require several linkages. These conventional arrangements are unsuitable for more compact fastening tools, such as tackers and hand staplers, which do not have enough space to accommodate complicated, multi-piece linkages.

To date, conventional attempts to solve the problem in the space-sensitive environment of a tacker or hand stapler have built-in disadvantages. For example, one stapler uses a contact arm that includes a curved flexible member mounted at one end of the contact arm. The curved flexible member is configured to engage an operator of an electrical switch to close the switch when the contact arm is pressed against a work surface. However, the electrical switch is disposed so that the switch operator is oriented generally parallel to the axis of movement of the contact arm. Accordingly, the flexible member must be curved in such a way as to engage the switch operator at just the right point to close the switch when the contact arm is moved in response to engaging a work surface. Accordingly, the curvature of the flexible member must be tightly controlled during manufacture or the switch operator may become overstressed, thus adding cost to the manufacturing process.

Another feature associated with fastening tools, particularly multi-purpose compact fastening tools such as tackers and hand staplers, is the ability to drive fasteners having different sizes and configurations. For example, an ideal compact fastening tool would be configured to drive all five of the following:
“U”-shaped fasteners or cable staples having a first width, such as STANLEY® CT100 Series and ARROW® T25™ staples;
Flat narrow-crown staples having the first width, such as STANLEY® CT300 Series and ARROW® T20™ staples;
Staples having a second width greater than the first width (wide-crown staples), such as STANLEY® TRA700 Series, DEWALT® DWHTTA700 Series, BOSTICH® BTA700 Series and ARROW® T50® staples;
Brads, such as STANLEY® SWKBN Series, BOSTICH® BT1300 Series and ARROW® BN18™ brads; and
⅝″ 18GA headless pins.

A difficulty in accommodating such a diverse array of fastener sizes and shapes in a single compact fastening tool is maintaining the perpendicular orientation of the fasteners relative to the work surface, as the fasteners are being driven along a drive path by the driver. This generally requires that each leg of the fastener be guided side-to-side, as well as fore-and-aft.

Conventional attempts to solve this problem have been unsatisfactory. For example, one conventional system uses a complicated set of guide plates and two individually-pivoting confining elements. One confining element bears against one leg of a fastener, depending on size, while an interior side of one of the plates guides the other leg of the fastener. Each confining element pivots separately from the other confining element, so each confining element requires a separate spring member to bias it into contact with a fastener leg. Consequently, in addition to its complexity, this system must be configured so that the individually-moving confining elements are accurately aligned with the legs of various sizes of fasteners, which means that the system is also vulnerable to deviations in manufacturing tolerances. Also, the structure of the system does not permit driving brads or headless pins.

Another unsatisfactory system also uses individual assisting members to help guide fasteners. Each such assisting member requires two coil springs to bias each assisting member linearly into individual, separate guiding engagement with the fastener. This is another complicated system that entails additional costs, a greater opportunity for variance from manufacturing tolerances, and a higher chance of malfunction.

What is needed, therefore, is a compact fastening tool such as a tacker or hand stapler that uses a simple, yet effective contact arm system, as well as an uncomplicated, easily-controllable fastener guide system that can guide at least the five different types of fasteners set forth above.

### SUMMARY OF THE INVENTION

Accordingly, in one embodiment of a fastening tool of the present invention, a contact arm system includes an elongated member disposed in the fastener tool housing and having a first end and a second end, the second end including a work surface-engaging portion. A first biasing agent, such as a coil spring, is disposed between the first end of the elongated member and a switch operator of an electric switch, the switch operator being oriented generally transverse to the axis of the coil spring. The coil spring is in constant, direct engagement with the switch operator. If desired, the first end of the elongated member may include a portion formed of electrically-insulating material. A second biasing agent is disposed between a portion of the housing and the elongated member and biases the work surface-engaging portion outwardly from the housing. The elongated member is movable from a first position in which the electrical switch is open to a second position in which the coil spring causes the switch operator to close the switch, responsive to the work surface-engaging portion having been pressed against the work surface against the bias of the second biasing agent.

The contact arm system of the present invention thus requires no linkages, and is therefore much simpler and more compact than conventional systems, and consequently less prone to malfunction. Also, using a coil spring (which requires no extra-tight tolerances to manufacture) to engage the switch operator means that the switch operator can be repetitively actuated without over-stressing the material of the switch operator. Furthermore, causing the coil spring to directly contact the switch operator attenuates any shock which may be transmitted to the switch when the fastening tool is dropped upon, or is slammed against, a work surface. In addition, by disposing the coil spring at the first end of the elongated member so that the coil spring always engages the switch operator, any risk of misalignment of the coil spring with the switch operator when the work surface-engaging portion engages the work surface is eliminated.

In another embodiment, the contact arm system includes an elongated member having a work surface-engaging portion which includes a tool alignment slide slidably disposed on the housing and configured to assist in aligning the fastening tool with the work surface. The tool alignment slide defines an embossed member having a ledge portion directed toward the elongated member. The elongated member defines a tab disposed above the ledge portion, such that movement of the alignment slide responsive to engagement with the work surface causes the ledge portion to move the tab so that the elongated member moves toward the switch operator. Thus the advantages of a device to align the tool with the work surface can be incorporated into the contact arm system without using additional parts, and with little or no added expense.

A fastener guide system of the present invention includes a driver guide, a fastener guide, and a biasing agent. The driver guide is disposed in the housing for guiding the driver along a drive path, and defines a generally rectangular channel including a base portion and two parallel side portions generally perpendicular to the base portion. The channel base portion in turn defines two elongated through-slots generally parallel to the side portions. The fastener guide is configured as a single unitary body including a pivot head and two parallel guide fingers connected to and moving in unison with the pivot head. The pivot head is pivotably connected to the housing of the fastening tool; the biasing agent is attached to the fastener guide and is engaged with a portion of the housing to bias the guide fingers to pivot simultaneously through respective elongated slots and into the drive path. The elongated slots and the guide fingers are configured to guide, for example, the legs of “U”-shaped fasteners (such as staples) having a first width. One of the elongated slots and one of the fastener guide fingers are configured also to guide brads and headless pins. The driver guide itself is configured to guide “U”-shaped fasteners having a second width greater than the first width.

When the driver of the fastening tool drive system moves along the driver guide, the driver causes the guide fingers to progressively retract back into respective elongated slots against the bias of the biasing agent. However, the guide fingers are so configured as to enable a portion of the guide fingers to continue to engage the leg of a fastener as the driver drives the fastener into the work surface, even as the guide fingers retract.

Thus the fastener guide system is able to accommodate at least the five different types of fasteners described above, while using a single unitary body to which is attached a single biasing agent, such as an elongated resilient member. This configuration has several advantages. First, the guide fingers move in unison and are both biased by a single biasing agent, such as an elongated resilient member, thereby causing respective guide fingers simultaneously to engage the legs, for example, of a “U”-shaped fastener, or staple. Thus, movement of the guide fingers is easily controlled, as is their respective alignment with the various types of fasteners. Second, the fastener guide system is much simpler than conventional systems; this therefore yields a less expensive system with fewer opportunities for malfunction. Third, the compact, uncomplicated configuration of the fastener guide system of the present invention allows it to be used in the space-sensitive environment of a tacker or hand fastening tool.

If desired, one of the guide fingers may be made shorter than the other to allow for a closer proximity of the contact arm to the drive path, thereby making the fastener guide system even more compact. Also, the fastener guide may be configured to include only one guide finger, and the driver guide may define just one elongated slot corresponding to the fastener guide finger, and may be configured to guide the particular array of types of fasteners used in the fastening tool.

In short, the compact nature of both the contact arm and the fastener guide systems of the present invention enables them to be used in several types of fastening tools, including without limitation tackers and hand staplers.

### BRIEF DESCRIPTION OF THE DRAWINGS

The above-mentioned and other features and advantages of this invention, and the manner of attaining them, will become more apparent and the invention will be better understood by reference to the following descriptions of embodiments of the invention taken in conjunction with the accompanying drawings, wherein:

FIG. 1 is a perspective view of one embodiment of a fastening tool of the present invention.

FIG. 2 is an exploded perspective view of the fastening tool of FIG. 1.

FIG. 3A is a front perspective detail view of the fastening tool of FIG. 1, with portions removed for clarity, and showing a tool alignment slide positioned above a work surface.

FIG. 3B is a view similar to that of FIG. 3A, showing the tool alignment slide having engaged the work surface.

FIG. 4 is an enlarged perspective detail view, taken from below, of the nose portion of the fastening tool of FIG. 1.

FIG. 5 is an enlarged perspective detail view, taken from the front, of the tool alignment slide of the fastening tool of FIG. 1.

FIG. 6A is an enlarged perspective detail view of the contact arm system of the fastening tool of FIG. 1.

FIG. 6B is a partial enlarged sectional detail view taken along lines 6B-6B of FIG. 6A.

FIG. 7 is an enlarged exploded perspective detail view of the fastener guide system of the fastening tool of FIG. 1.

FIGS. 8A-8C are enlarged rear perspective, side elevational, and front perspective detail views, respectively, of the fastener guide of the fastener guide system of FIG. 7.

FIG. 9 is a rear perspective view of the fastening tool of FIG. 1, with portions removed for clarity.

FIG. 10 is an enlarged perspective detail view of the circled portion of FIG. 9.

FIG. 11 is a perspective detail view of the left side of the housing of the fastening tool of FIG. 1, showing the mounting location of the fastening guide.

FIG. 12 is an enlarged perspective detail view of the circled portion of FIG. 11.

FIG. 13 is a partial enlarged perspective detail view of the lower left front of the fastening tool of FIG. 1, with portions removed for clarity, and showing a cable staple and driver.

FIG. 14 is a partial enlarged perspective detail view, taken from one side, of the nose portion of the fastening tool of FIG. 1, with portions removed for clarity.

FIG. 15 is a view similar to that of FIG. 14, taken from the other side.

FIG. 16 is an enlarged perspective detail view, with portions removed for clarity, of a stick of fasteners positioned against a driver guide of the fastening tool of FIG. 1, and illustrating the position of the driver before engaging a fastener, such as a cable staple.

FIG. 17 is a view similar to that of FIG. 16 and illustrating the position of the driver as it separates a cable staple from the stick of fasteners.

FIG. 18 is an enlarged, partial perspective schematic detail view, taken from the front, of the nose portion of the fastening tool of FIG. 1, and illustrating the interaction of the fastener guide system with the cable staple, with occluded portions shown in lighter line-weight.

FIG. 19 is a schematic elevational detail view taken along lines 19-19 of FIG. 18, with occluded portions shown in lighter line-weight.

FIG. 20 is a view similar to that of FIG. 18, and illustrating a wide-crown staple just prior to impact by the driver of the fastening tool of FIG. 1.

FIG. 21 is a view similar to that of FIG. 19, and partially in section, taken along lines 21-21 of FIG. 20.

FIG. 22 is a view similar to that of FIG. 20, illustrating the interaction of the driver with the wide-crown staple and with the fastener guide system of the fastening tool of FIG. 1.

FIG. 23 is a view similar to that of FIG. 21, taken along the lines 23-23 of FIG. 22.

FIG. 24 is a view similar to that of FIG. 22, illustrating the interaction of the fastener guide system of the fastening tool of FIG. 1 with a flat narrow-crown staple.

FIG. 25 is a view similar to that of FIG. 24, illustrating the interaction of the fastener guide system of the fastening tool of FIG. 1 with a stick of headless pins.

FIG. 26 is a view similar to that of FIG. 25, illustrating the interaction of the fastener guide system of the fastening tool of FIG. 1 with a headless pin.

FIG. 27 is a view similar to that of FIG. 26, illustrating the interaction the fastener guide system of the fastening tool of FIG. 1 with a brad.

FIG. 28 is a perspective detail view of another embodiment of the fastener guide system of the fastening tool of FIG. 1.

FIG. 29 is an exploded perspective detail view of the fastener guide system of FIG. 28.

FIGS. 30-34 are schematic perspective detail views, similar to those of FIGS. 20, 16 and 24, 26 and 27, illustrating the interaction of the second embodiment of the fastener guide system with wide-crown staples, cable staples, flat narrow-crown staples, headless pins, and brads, respectively.

Corresponding reference characters indicate corresponding parts throughout the several views. The exemplifications set out herein illustrate embodiments of the present invention, and such exemplifications are not to be construed as limiting the scope of the present invention in any manner.

### DETAILED DESCRIPTION OF THE INVENTION

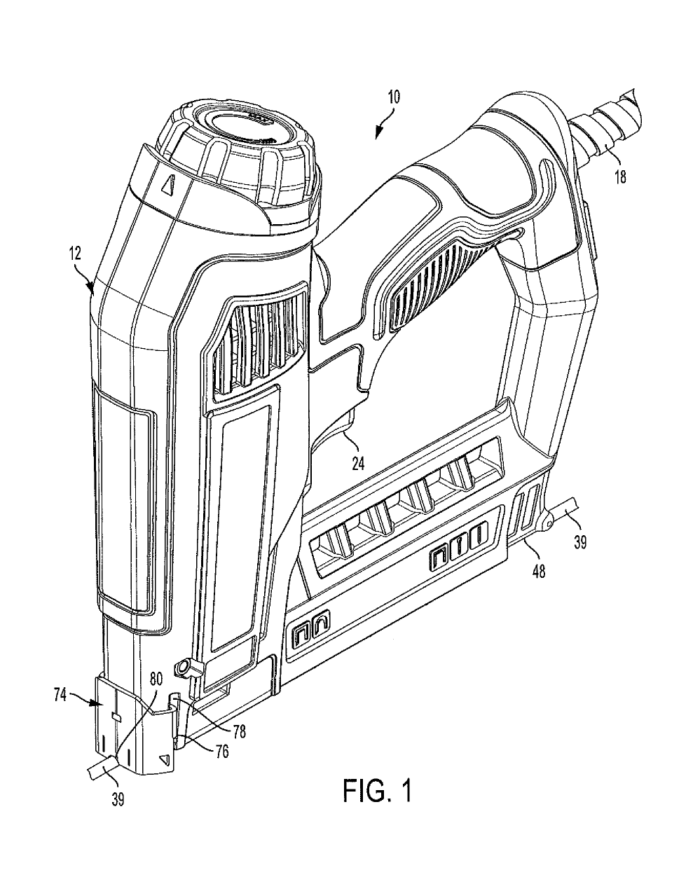

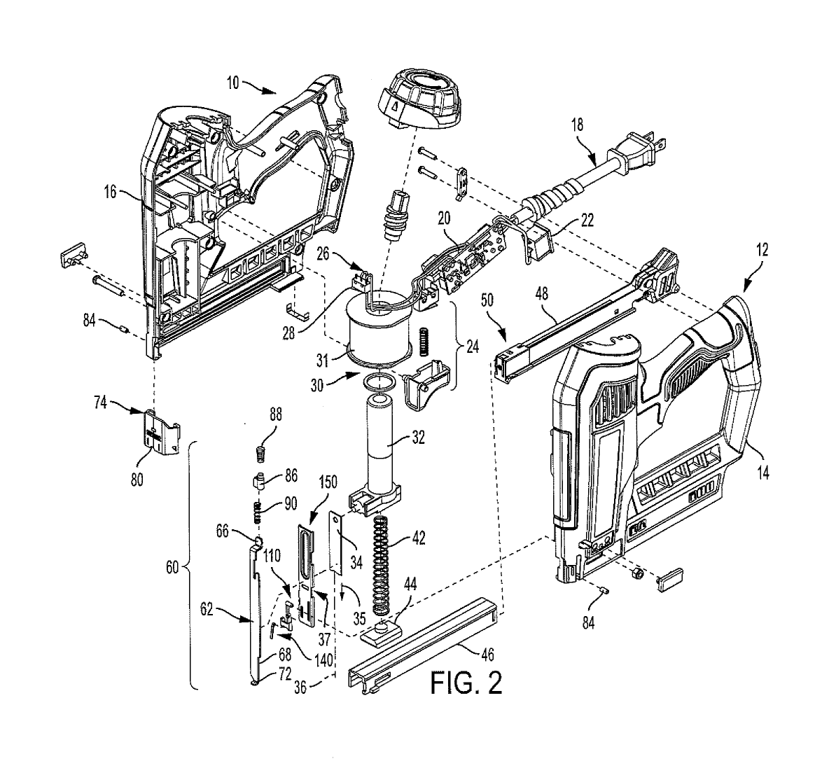

Referring now to the Drawings and particularly to FIGS. 1 and 2, a fastening tool 10 in accordance with an embodiment of the present invention includes a housing 12, which in turn includes a left housing portion 14 and a right housing portion 16. A power cord assembly 18 is disposed in the housing 12 and is connected to circuitry 20 for powering the fastening tool 10. Before the fastening tool 10 can be fired, three electrical switches connected in circuit with the circuitry 20 must be closed, namely a power switch 22, a trigger switch 24 and a safety switch 26. The safety switch 26 is normally open, and includes a switch operator 28.

Still referring to FIGS. 1 and 2, a fastener drive system 30 includes a solenoid 31 which drives an impulse lever 32, which in turn drives a driver 34 in a driving direction 35 along a drive axis 36 through a drive path 37. The driver 34, which may be formed with a concave portion 33 for driving cable staples, drives a fastener from a stick of fasteners 38 into a work surface 40. One of the many applications of the fastening tool 10 is driving such a fastener to anchor a cable 39 (FIG. 1) against the work surface 40. The fastener drive system 30 further includes a return spring 42 and a bumper 44.

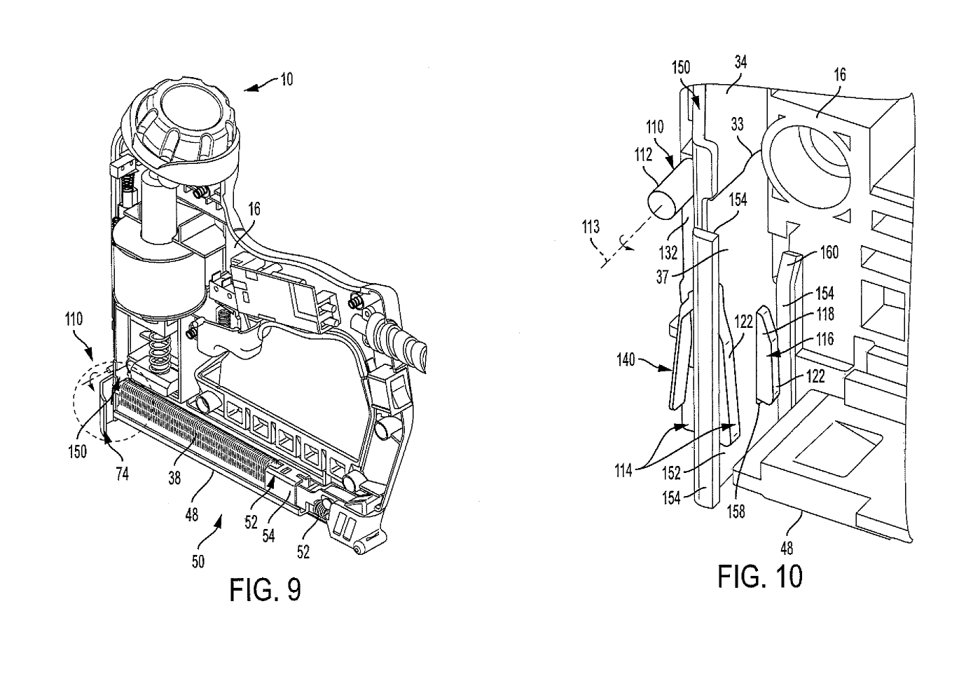

The stick of fasteners 38 is loaded onto a magazine 46, which in turn is loaded onto a core subassembly 48. Referring for the moment to FIG. 9, the core subassembly 48 includes a fastener biasing agent 50, which includes a spring 52 and a pusher 54. The fastener biasing agent 50 biases the stick of fasteners 38 into the drive path 37 of the driver 34.

As will be described in greater detail below, the fastening tool 10 also includes a contact arm system 60 and a fastener guide system 100.

At this point, it should be noted that, although the embodiments of the fastening tool 10 depicted in the Drawings are shown as electric tackers, it will be appreciated that the embodiments of the present invention can be incorporated in any fastening tool, including, without limitation, hand and power staplers, and nailers. Furthermore, although the embodiments of the contact arm system 60 and the fastener guide system 100 are shown being used in connection with a fastening tool having an electric-powered drive system, it will also be appreciated that the contact arm system 60 and the fastener guide system 100 may be employed in fastening tools using pneumatic, hydraulic, and gas/explosive drive systems, among others.

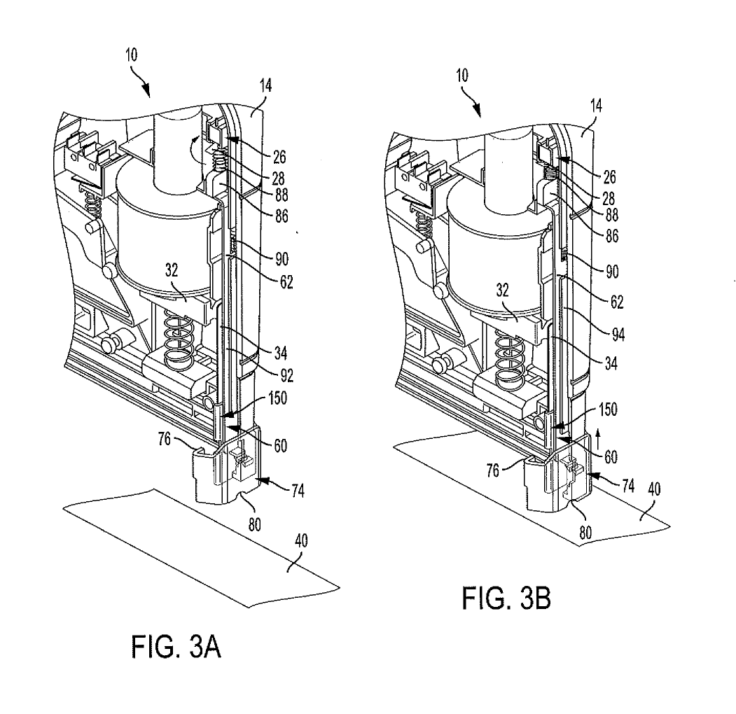

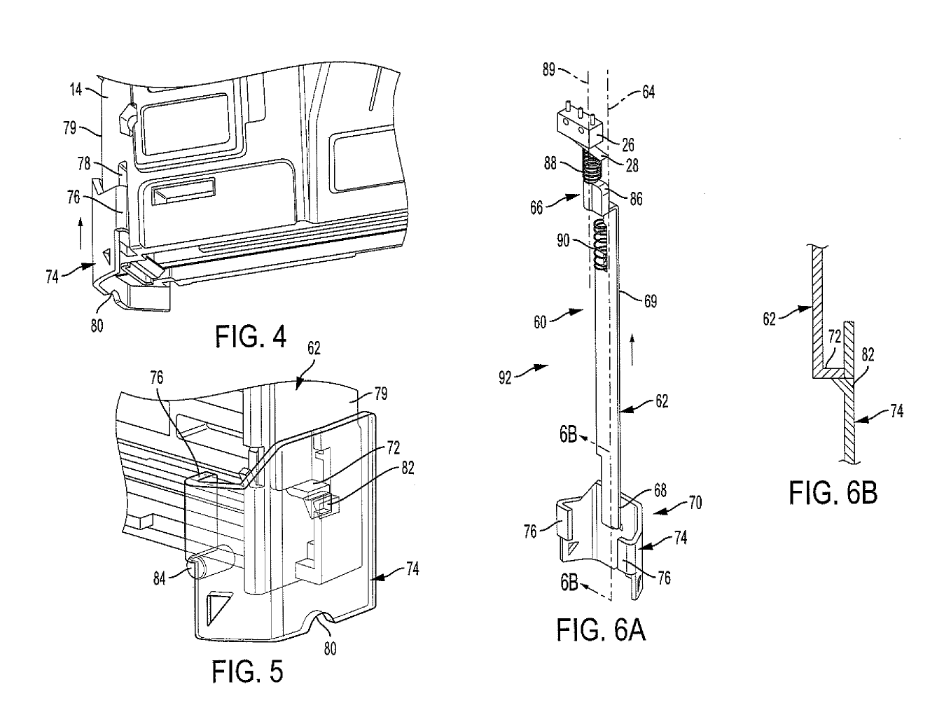

Returning to FIG. 2, and with further reference to FIGS. 3A and 3B, 4, 5, and 6A and 6B, the contact arm system 60 includes a contact arm or elongated member 62, a tool alignment slide 74, and first and second biasing agents 88 and 90. The elongated member 62 defines an axis 64 and includes a first end 66 and a second end 68, separated by a connecting portion 69 disposed parallel to the drive axis 36. The elongated member 62 is configured for movement in the housing 12 toward and away from the work surface 40. The second end 68 defines a work surface-engaging portion 70, which in turn defines a transverse tab 72. Referring particularly to FIGS. 4, 5, 6A and 6B, the tool alignment slide 74 defines two parallel ribs 76 slidably disposed for vertical movement (relative to the work surface) in grooves 78 formed a nose portion 79 of the housing 12, as shown by the arrow in FIGS. 3B and 4. The tool alignment slide 74 also defines a tool alignment feature 80, such as a U-shaped notch, for assisting the fastening tool operator to align the fastening tool 10 on the work surface 40, such as by placing the fastening tool against the work surface so that the tool alignment feature is aligned with a cable to be stapled against the work surface (FIG. 1). It can be recognized that the tool alignment feature 80 may have any configuration that helps a fastening tool operator align the fastening tool 10 with the work surface 40.

Referring now to FIGS. 5 and 6B, the tool alignment slide 74 also defines a transverse embossed feature or ledge 82, which extends from the tool alignment slide toward and beneath the transverse tab 72. Therefore, when the tool alignment slide 74 is pressed against the work surface 40, the tool alignment slide moves vertically (relative to the work surface) in the grooves 78, and the ledge 82 moves the transverse tab 72, and consequently the elongated member 62, vertically as well. This yields a compact arrangement which requires no parts other than the elongated member 62 and the tool alignment slide 74, and is therefore simple and inexpensive to manufacture. However, it can be appreciated that any satisfactory interface between the tool alignment slide 74 and the elongated member 62 may be employed which causes the elongated member to move when the fastening tool 10 engages a work surface 40. It can also be appreciated that, if desired, the work surface-engaging portion 70 of the elongated member 62 may assume any suitable configuration.

As shown in FIGS. 4 and 5, a stop member 84 is disposed between the housing 12 and a portion of the tool alignment slide 74. The stop member 84 is configured to prevent the tool alignment slide 74 from extending past the housing 12 beyond a preferred distance, and may be formed in any satisfactory configuration from any satisfactory material. For example, the stop member 84 may be formed as medium carbon-steel cylinders or pins, one being positioned on each side of the housing 10.

Referring once again to FIGS. 2, 3A, 3B and 6A, the contact arm system 60 further includes an electrically insulating tip 86 positioned at the first end 66 of the elongated member 62. The first biasing agent, such as a coil spring 88, is disposed on a portion of the electrically insulating tip 86 so that a longitudinal axis 89 of the coil spring 88 is parallel to the axis 64 of the elongated member 62. The coil spring 88, electrical safety switch 26, and switch operator 28 are arranged so that the switch operator is disposed generally transverse to the coil spring axis 89, and so that the coil spring 88 always contacts the switch operator 28. The coil spring 88 is also configured so that, even if the fastening tool 10 is dropped, causing the tool alignment slide 74 to strike the work surface 40, or the fastening tool operator slams the fastening tool against the work surface, the force transmitted to the switch operator 28 by the concomitant vertical movement of the elongated member is sufficiently attenuated so as not to damage the switch operator. An additional benefit of the use of the coil spring 88 is that it is easy to manufacture, and its orientation relative to the switch operator 28 can be easily controlled so that the electrical switch 26 will consistently be closed or actuated when the tool alignment slide 74 is pressed against a work surface 40.

Still referring to FIGS. 2, 3A, 3B and 6A, the second biasing agent 90, such as another coil spring, is disposed between the housing 12 and a portion of the elongated member 62, and is configured to bias the elongated member and tool alignment slide 74 outwardly of the fastening tool housing 12. The second biasing agent 90 is also configured to act as an additional shock absorber, protecting the switch operator 28 against sharp impacts of the tool alignment slide 74 against a work surface 40.

In operation, when a fastening tool operator presses the tool alignment slide 74 against a work surface 40, the elongated member 62 is moved upwardly against the bias of the second biasing agent 90 from a first position 92, as shown in FIG. 3A, to a second position 94, as shown in FIG. 3B. The first biasing agent or coil spring 88 is compressed against the switch operator 28 until the normally-open electrical switch 26 is closed or actuated. Now, when the fastening tool operator actuates the trigger switch 24, the fastener tool 10 can fire, assuming the power switch 22 has been turned on. When the fastening tool 10 is lifted away from the work surface 40, the second biasing agent 90 returns the elongated member 62 to its first position 92, the electrical switch 26 returns to its open state, and the fastening tool 10 can no longer fire, even if the fastening tool operator were to actuate the trigger switch 24.

Consequently, the contact arm system 60 provides an uncomplicated yet effective means for actuating an electrical switch, and requires no space-intensive linkages. The contact arm system 60 further insulates the switch operator 28 and the electrical switch 26 from sharp impacts of the fastening tool 10 against a work surface 40, and yet provides a means for consistently actuating the electrical switch when the tool alignment slide 74 is pressed against the work surface. The contact arm system 60 not only achieves these results inexpensively and consistently, but simultaneously provides a means for the fastening tool operator to quickly align the fastening tool 10 with the work surface 40.

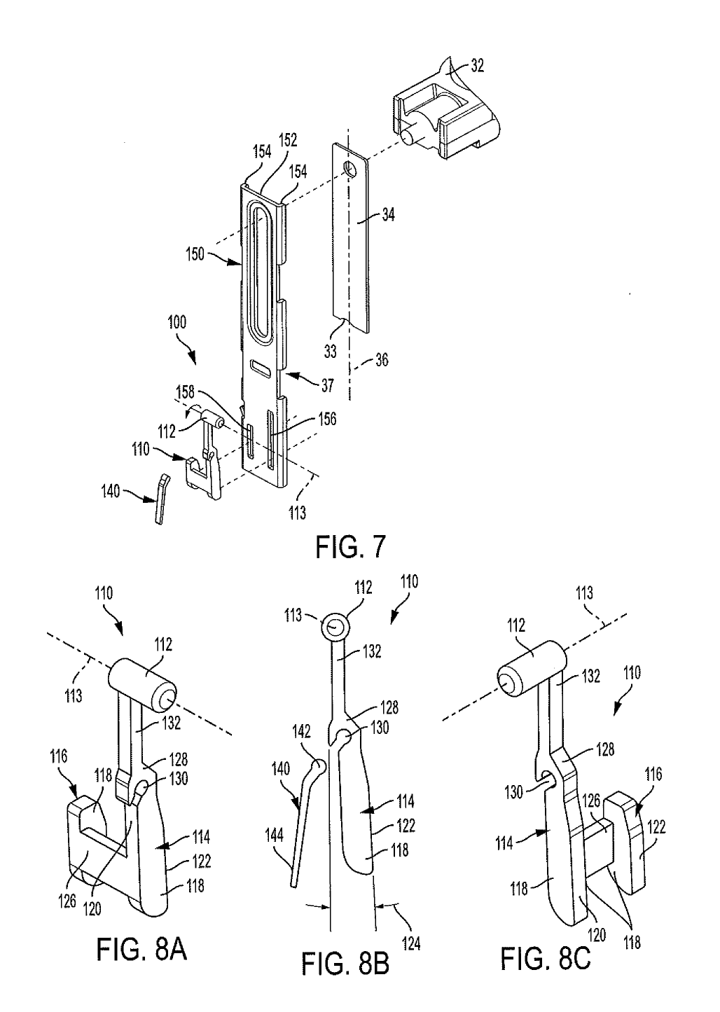

Thus the contact arm system 60 is particularly desirable for use in the compact environment of a tacker or hand stapler. Another feature of the fastening tool 10 of the present invention is similarly space-effective and uncomplicated, namely, the fastener guide system 100, illustrated in FIGS. 7, 8A-8C, 9-15, and 16-26.

Referring first to FIGS. 7, 8A-8C, and 9 and 10, the fastener guide system 100 includes just three elements, namely a fastener guide 110, a fastener guide biasing agent 140, and a driver guide 150. The fastener guide 110, as particularly shown in FIGS. 8A-8C, is a one-piece, unitary structure, and is preferably formed of metal, such as steel. However, the fastener guide 110 can be made of any material which can be formed to a specified shape, and which is resistant to abrasion. The fastener guide 110 includes a pivot head 112 defining a pivot axis 113, and two parallel guide fingers—a long guide finger 114 and a short guide finger 116. The guide fingers 114, 116 each define side surfaces 118 formed on both sides of the guide fingers, a rear edge 120 and a front edge 122. As shown in FIG. 8B, the front edges 122 of both guide fingers 114, 116 create forward angles 124 with respect to a vertical. The guide fingers 114, 116 are joined by a finger connection portion 126. An upper portion of the long guide finger 114 defines a junction portion 128, which further defines a fastener guide biasing agent receptacle 130. The junction portion 128 is connected by a pivot head connection portion 132 to the pivot head 112. Consequently, as a result of this unitary structure, all of the elements of the fastener guide 110 move in unison.

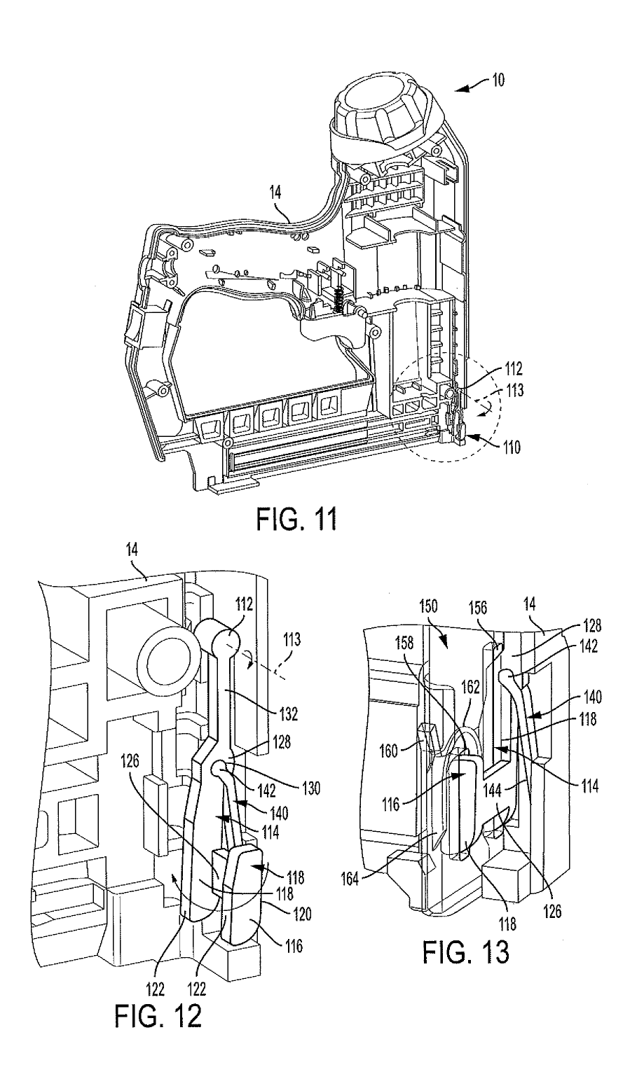

As illustrated in FIGS. 7 and 11-13, the fastener guide biasing agent 140 (the second element of the fastener guide system 100) defines a fastener guide connection portion 142, which may be connected to the fastener guide biasing agent receptacle 130 with a tight fit. As shown in FIGS. 11-13, the fastener guide pivot head 112 is pivotably disposed in the left housing portion 14 about pivot axis 113, so that a housing engagement portion 144 of the fastener guide biasing agent 140 bears against a portion of the left housing portion 14. Consequently, the fastener guide 110 and fastener guide biasing agent 140 may be so configured as to bias the guide fingers 114, 116 into the drive path 37 of the driver 34 (See curved arrow in FIGS. 7, 11 and 12. Note that unless otherwise indicated, the curved arrow around the pivot axis 113 will designate the direction of bias in each of the Figures.) It should be understood, however, that the fastener guide 110 and fastener guide biasing agent 140 may be mounted in any suitable location of the housing 12, provided the guide fingers 114, 116 are biased into the drive path 37 to satisfactorily guide fasteners being driven by the driver 34.

It is preferred that the fastener guide biasing agent 140 be formed as a one-piece elastomer, such as polypropylene (PP) or polyoxyethylene (POM), but any pliable plastic material that can be manufactured to be thin, easy to assemble, and with the ability to withstand high speed and frequent bending, will be acceptable. If desired, the fastener guide biasing agent 140 may be formed as a multi-piece structure using different materials. However, the structure of the one-piece fastener guide biasing agent 140, as shown in the Drawings, conserves space and material and is a simple, low-cost way to ensure that both fastener guide fingers are biased to pivot simultaneously into the drive path 37, and thus simultaneously engage, for example, both legs of a “U”-shaped fastener or staple, which ensures that fasteners are consistently and accurately guided all along the drive path.

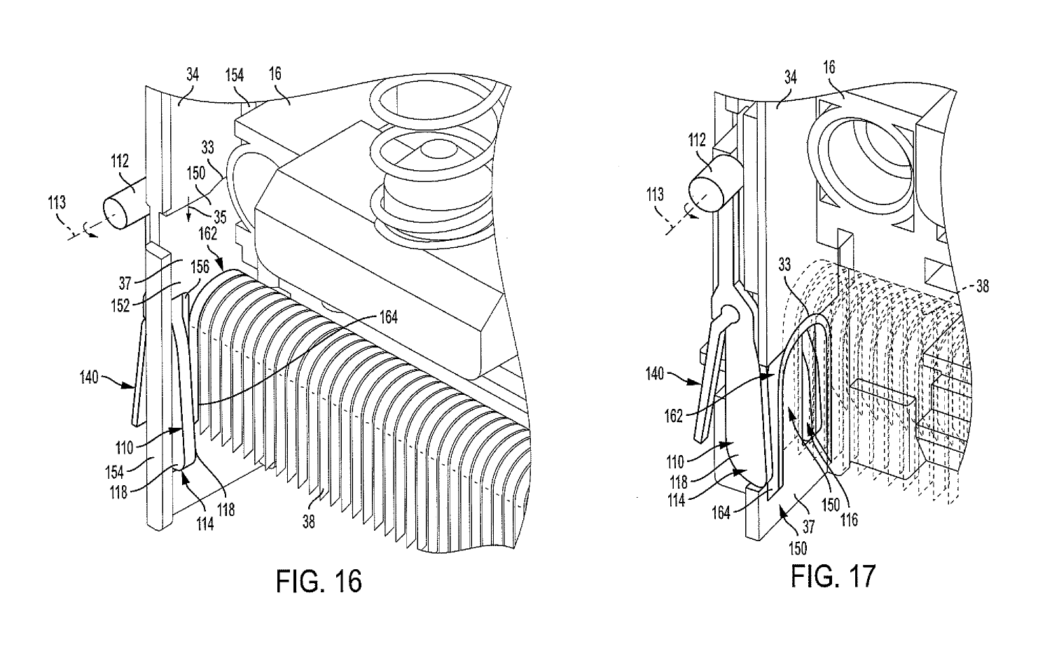

As is particularly shown in FIG. 7, the driver guide 150 (the third element of the fastener guide system 100) is configured as an elongated channel having a “U”-shaped cross-section. The channel defines a base portion 152 upon which are disposed two parallel side portions 154. The base portion 152 defines two parallel elongated through-slots, a long slot 156 and a short slot 158, which are configured and disposed so that the long and short fastener guide fingers 114, 116, respectively, may freely pass therethrough under the bias of the fastener guide biasing agent 140. The width of the channel between side portions 154 is configured so that the base portion 152 and the parallel side portions 154 slidably guide the driver 34 along the drive path 37. (See, for example, FIGS. 16 and 17.) As will be seen shortly, the width of the channel is also configured to guide certain “U”-shaped fasteners, such as wide-crown staples described above under “Description of the Related Art.” The driver guide 150 is equipped with a driver guide tab 160, which positions the driver guide relative to the housing 12 so that the fastener guide 110 and driver guide are accurately aligned.

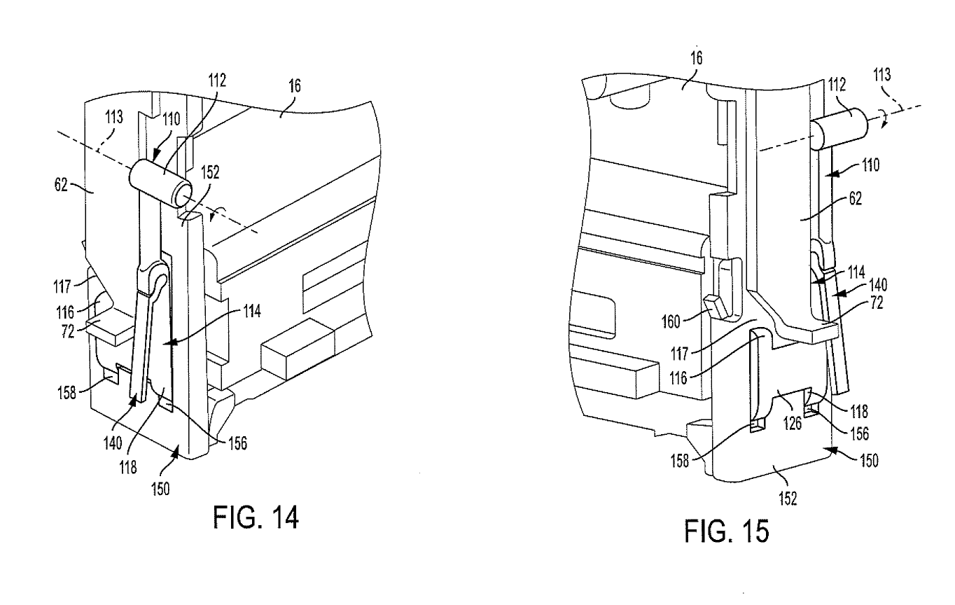

FIGS. 14 and 15 illustrate the interrelationship among the fastener guide 110, the driver guide 34 and the contact arm system 60. One of the guide fingers 114, 116 is configured to be shorter than the other, as shown in FIG. 15, to provide clearance 117 for the elongated member 62 of the contact arm system 60. Thus the elongated member 62 can be disposed substantially parallel, and very close, to the base portion 152 of the driver guide 150, thereby resulting in a more compact fastening tool then would have been the case had the guide fingers been configured to have the same length. However, if space and size are no objects, the fastener guide fingers 114, 116 may be formed of equal lengths.

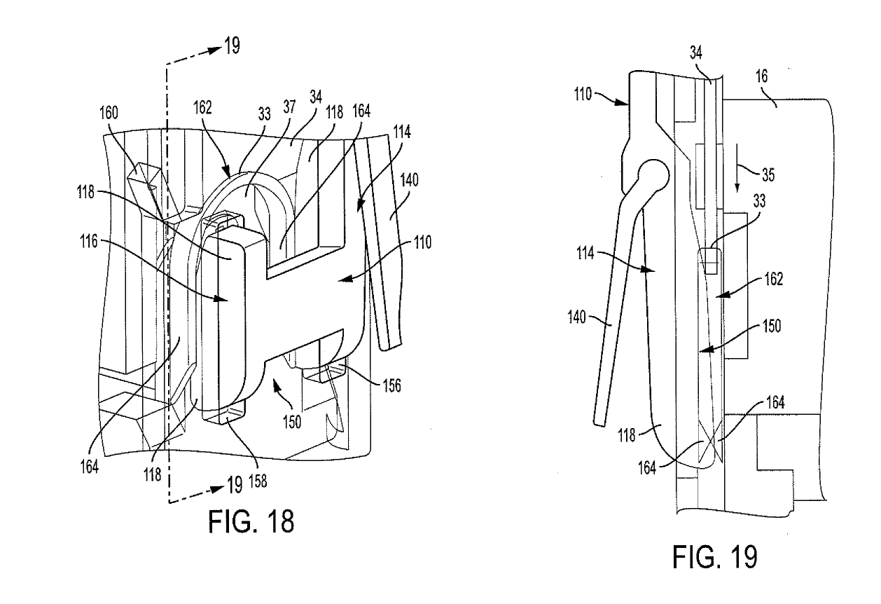

An example of the interaction of the fastener guide system 100 with one of the fasteners described above under “Description of the Related Art” is illustrated in FIGS. 16-19 with respect to cable staples 162, having a first width W1. FIG. 16 shows a stick of fasteners 38 (in this case, cable staples 162) positioned against the driver guide 150. Thus the stick of fasteners 38 and the driver guide 150 provide fore-and-aft stability for the cable staples 162 as they are driven along the drive path 37. As will be described next, the fastener guide 110 provides side-to-side, or lateral stability. FIG. 16 shows that a side surface 118 of the long guide finger 114 engages one of the legs 164 of the cable staple 162, the long guide finger 114 having been biased through the long through-slot 156 of the driver guide 150 and into the drive path 37 by the fastener guide biasing agent 140 (see curved arrow). The other leg 164 of the cable staple 162 may be guided by one of the driver guide side portions 154. (Note that in FIGS. 18 and 19, for clarity, the fastener guide 110 is shown in heavier line-weight than the cable staple 162. Occluded portions of FIG. 19 are also shown in lighter line-weight.) If desired, the elements of the fastener guide system 100 may be configured so that when the side surface 118 of the long guide finger 114 engages one of the legs 164 of the cable staple 162, this engagement will cause the other leg 164 to bear against a side portion 154 of the driver guide 150. On the other hand, as shown in FIG. 18, the short guide finger 116 may also guide an inside surface of the other leg 164, so that the other leg may be stabilized by, and sandwiched between, a side portion 154 of the driver guide 150 and a side surface 118 of the short guide finger 116. Accordingly the fastener guide system 100 may be configured so that both guide fingers 114, 116 engage respective legs 164 of a fastener, such as the cable staple 162.

Returning to FIG. 17, and with further reference to FIGS. 18 and 19, as the driver 34 is driven along the driver guide 150, the driver causes the guide fingers 114, 116 to progressively retract into their respective through-slots 156, 158 against the bias of the fastener guide biasing agent 140. However, as shown in FIGS. 18 and 19, even as the guide fingers 114, 116 retract, their respective forward angles 124 ensure that at least portions of both the long and short guide fingers 114, 116 continue to provide lateral stability to the staple legs 164.

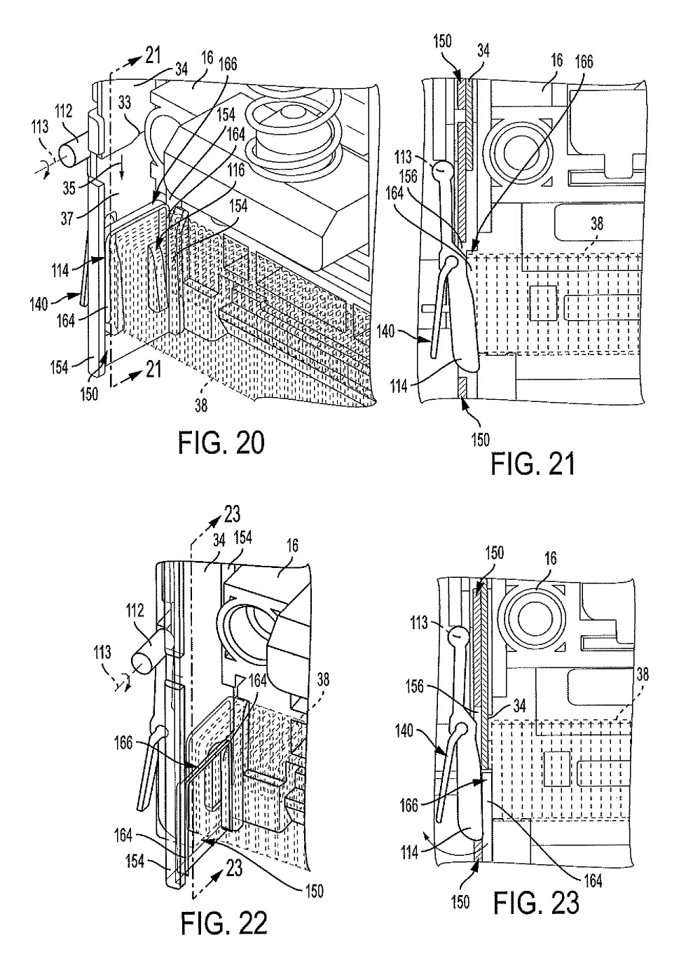

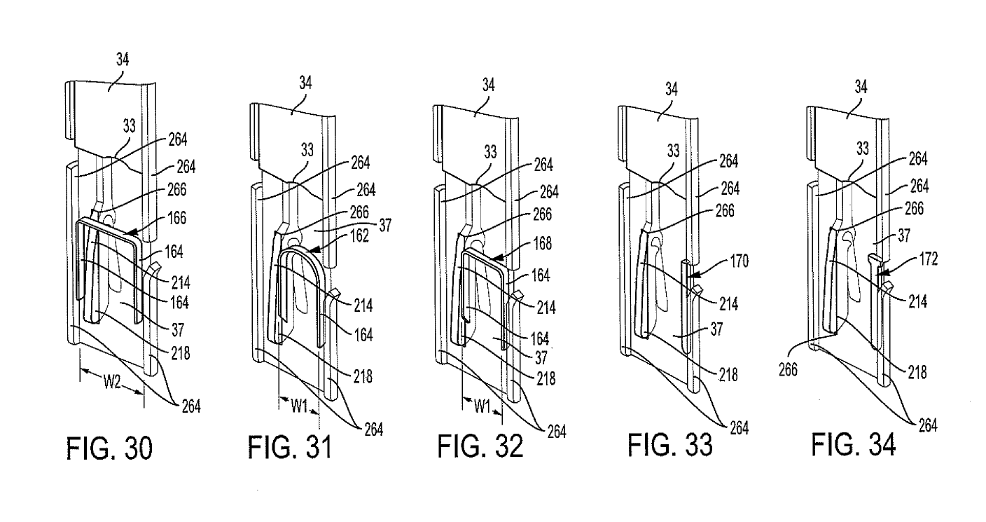

FIGS. 20-23 show the interaction of the fastener guide system 100 with wide-crown staples 166 having a width W2 greater than that of the cable staples 162. (FIGS. 30-32 illustrate the relative differences in widths W1 and W2.) In this case, as shown in FIGS. 20 and 21, when the stick of fasteners 38 presents a wide-crown staple 166 to the drive path 37, the stick of fasteners and the driver guide provide fore-and-aft stability, as was the case in connection with cable staples 162. However as shown in FIGS. 20-23, first the stick of fasteners 38, then the driver 34, cause both guide fingers 116, 118 to pivot back through their respective through-slots 156, 158, and, as shown by the curved arrow in FIG. 23, completely out of the drive path 37 against the bias of the fastener guide biasing agent 140. Lateral stability is now provided by both side portions 154 of the driver guide 150 engaging respective legs 164 of the wide-crown staple 166.

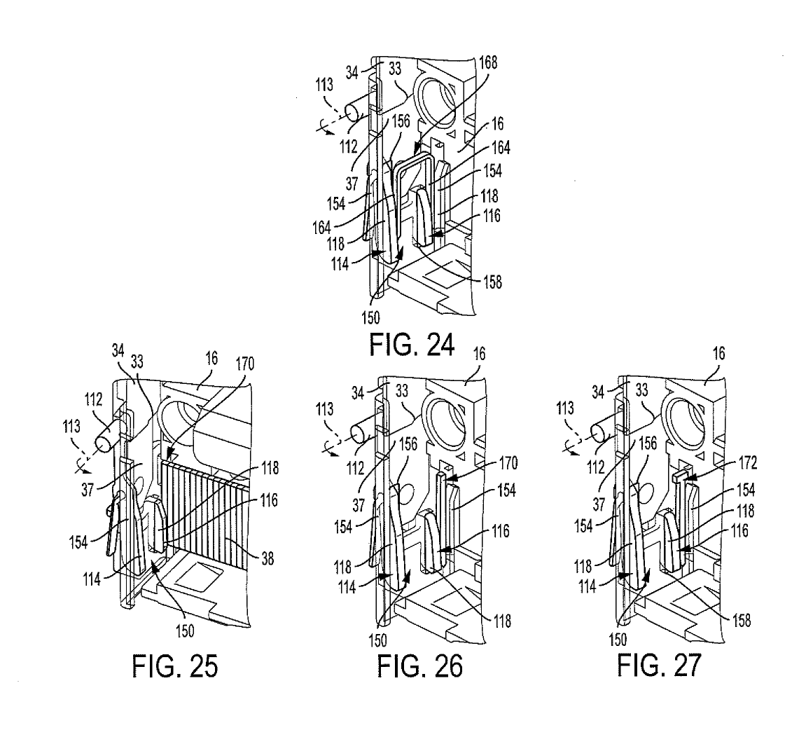

In a similar fashion, FIG. 24 shows the interaction of the fastener guide system 100 with a narrow-crown staple 168, also having a first width W1. Thus, the fastener guide side surfaces 118 of both guide fingers 114, 116 engage respective legs 164 of the narrow-crown staple 168, the short guide finger 116 causing one leg of the staple 168 to bear against a side portion 154 of the driver guide 150.

FIGS. 25 and 26 illustrate the interaction of the fastener guide system 100 with a headless pin 170 (described above under “Description of the Related Art”), the guide fingers 114, 116 having been biased into the drive path 37 by the fastener guide biasing agent 140 (see curved arrows). In this case, as shown in FIG. 25, the headless pin is guided fore-and-aft by the stick of fasteners 38 and the driver guide 150, and, as shown in FIG. 26, the headless pin 170 is guided laterally by the short guide finger 116 and a side portion 154 of the driver guide 150. Brads 172 are guided in the same way as are the headless pins 170, as illustrated in FIG. 27.

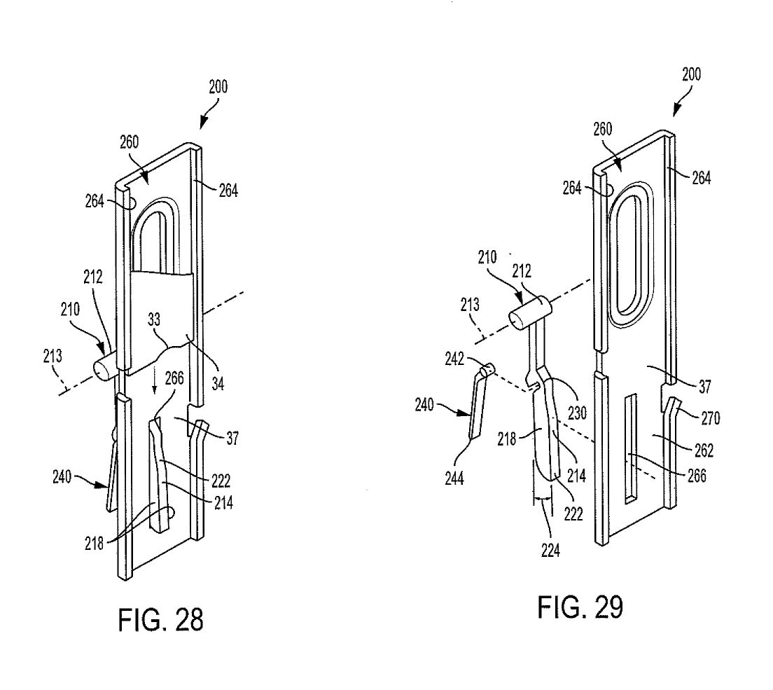

If desired, the fastener guide system can be built around a fastener guide having a single guide finger 214. This embodiment is shown in FIGS. 28 and 29, in which a fastener guide system 200 includes a fastener guide 210, a fastener guide biasing agent 240 and a driver guide 260. In this embodiment, the fastener guide biasing agent 240 may be formed in the same fashion as the fastener guide biasing agent 140, and the driver guide 260 may be the same as the driver guide 160, except there is only a single through-slot 256 sized to accommodate the guide finger 214. A fastener guide connection portion 242 of the fastener guide biasing agent 240 is connected to a fastener guide biasing agent receptacle 230, and the housing engagement portion 244 of the fastener guide biasing agent engages the housing 12, in the same ways as were described above with respect to the fastener guide 110. A front edge 222 of the guide finger 214 is disposed at a forward angle 224 with a vertical. A pivot head 212 is pivoted about a pivot axis 213 in a direction to pivot the guide finger 214 through the elongated slot 266

Accordingly, as shown in FIGS. 30-34, the fastener guide system 200 operates in the same fashion as was described above with respect to the fastener guide system 100, except that a side surface 218 of only one guide finger 114 engages a leg 164 of the cable staple 162 and of the flat narrow crown staple 168. In addition, only the stick of fasteners 38, the base portion 252, and a side portion 254 of the driver guide 250, are used to provide stability to headless pins 170 and to brads 172, as shown in FIGS. 33 and 34. To maintain alignment of headless pins 170 and brads 172, the fastener guide 210, the magazine 46, and the core subassembly 48 should be constructed with much tighter tolerances than in the fastener guide system 100, and any gap between side portions 54 of the driver guide 50 and the core subassembly 48 should be reduced.

It can now be seen that the contact arm system 60 and the fastener guide systems 100, 200 of the present invention require a minimum amount of space to function, and are uncomplicated but reliable. Thus a fastening tool which is constrained by space requirements, such as the solenoid-driven tacker 10 of the present invention, or a hand stapler, can easily be provided with means both for actuating an electrical switch, and for guiding at least five different types of fasteners along a drive path.

While the present invention has been described with respect to various embodiments of an electric tacker, the present invention may be further modified within the spirit and scope of this disclosure to apply to other products as well. This application is therefore intended to cover any variations, uses, or adaptations of the present invention using its general principles. Further, this application is intended to cover such departures from the present disclosure as come within known or customary practice in the art to which this invention pertains and which fall within the limitations of the appended claims.

What is claimed is:

1. A fastening tool, comprising:
a housing;
a fastener drive system disposed in the housing for driving a fastener into a work surface;
a normally-open electrical switch disposed in the housing and operatively associated with the fastener drive system, the electrical switch including a switch operator;
an elongated member disposed in the housing along an axis and having a first end and a second end, the second end including a work surface-engaging portion;
a first biasing agent defining an axis and disposed between the first end and the switch operator, the first biasing agent configured to directly contact the switch operator;
wherein the switch operator is oriented generally transverse to the axis of the first biasing agent; and further comprising:
a second biasing agent disposed between a portion of the housing and the elongated member and biasing the work surface-engaging portion outwardly from the housing;
wherein the elongated member is movable from a first position in which the electrical switch is open to a second position in which the first biasing agent causes the switch operator to close the switch, responsive to the work surface-engaging portion having been pressed against the work surface against the bias of the second biasing agent.

2. The fastening tool claimed in claim 1, wherein the first biasing agent is always in contact with the switch operator.

3. The fastening tool claimed in claim 1, wherein the first biasing agent includes a coil spring; and
wherein, when the work surface-engaging portion is pressed against the work surface, the elongated member compresses the coil spring sufficiently to cause the switch operator to close the electrical switch.

4. The fastening tool claimed in claim 3, wherein the first end includes a portion formed of electrically insulating material.

5. The fastening tool claimed in claim 4, wherein the work surface-engaging portion includes a tool alignment slide slidably disposed on the housing; and
wherein the tool alignment slide is configured to assist in aligning the fastening tool with the work surface.

6. A fastening tool, comprising:
a housing;
a fastener drive system disposed in the housing for driving a fastener into a work surface;
a normally-open electrical switch disposed in the housing and operatively associated with the fastener drive system, the electrical switch including a switch operator;
an elongated member disposed in the housing and having a first end and a second end, the second end including a work surface-engaging portion;
a first biasing agent disposed between the first end and the switch operator, and configured to cause the switch operator to close the electrical switch; and
a second biasing agent disposed between a portion of the housing and the elongated member and biasing the work surface-engaging portion outwardly from the housing;
wherein the work surface-engaging portion includes a tool alignment slide slidably disposed on the housing and configured to assist in aligning the fastening tool with the work surface;
the tool alignment slide defines an embossed member having a ledge portion directed toward the elongated member;
the elongated member defines a tab disposed above the ledge portion relative to the driving direction of movement of the driver toward the work surface;
movement of the tool alignment slide responsive to engagement with the work surface causes the ledge portion to move the tab so that the elongated member moves toward the switch operator; and
wherein the elongated member is movable from a first position in which the electrical switch is open to a second position in which the first biasing agent causes the switch operator to close the electrical switch, responsive to the tool alignment slide having been pressed against the work surface against the bias of the second biasing agent.

7. The fastening tool claimed in claim 6, wherein the first biasing agent directly contacts the switch operator.

8. The fastening tool claimed in claim 7, wherein the first biasing agent includes a coil spring always in contact with the switch operator.

9. The fastening tool claimed in claim 6, further comprising:
a stop member disposed between the alignment slide and the housing to limit the travel of the alignment slide in the direction of the work surface.

10. The fastening tool claimed in claim 6, wherein the drive system includes a driver disposed in the housing for movement along a drive axis; and
wherein the elongated member includes a portion disposed parallel to the drive axis.

11. A fastening tool, comprising:
a housing;
a fastener drive system disposed in the housing and including a driver for driving different-sized fasteners along a drive path and into a work surface;
a driver guide disposed in the housing for guiding the driver along the drive path; and
a fastener guide operatively associated with the driver guide and configured for guiding different-sized fasteners along the drive path;
wherein the fastener guide is a single unitary body including a pivot head and two guide fingers connected to, and moving in unison with, the pivot head; and
wherein the pivot head is pivotably connected to the housing, and the two guide fingers are configured to guide the fasteners along the drive path; and further comprising:
a biasing agent attached to the fastener guide and engaged with a portion of the housing, the biasing agent biasing the fastener guide fingers to pivot simultaneously into the drive path.

12. The fastening tool claimed in claim 11, wherein the fastener guide fingers are parallel to one another so that the fastener guide fingers simultaneously engage respective legs of a “U”-shaped fastener.

13. The fastening tool claimed in claim 11, wherein the driver guide defines a generally rectangular channel, the channel including a base portion and two parallel side portions generally perpendicular to the base portion;
the channel is configured to guide the driver along the drive path;
the channel defines two elongated slots generally parallel to the side portions and configured to allow respective fastener guide fingers to freely pass therethrough;
the biasing agent normally biases the fastener guide fingers to simultaneously pivot through respective elongated slots and into the drive path;
at least one of the fastener guide fingers and at least one of the respective elongated slots are configured to guide one or more legs of “U”-shaped fasteners having a first width;
one of the fastener guide fingers and one of the respective elongated slots are configured to guide brads and headless pins; and
wherein the channel is also configured to guide the legs of “U”-shaped fasteners having a second width greater than the first width.

14. The fastening tool claimed in claim 13, further comprising:
a core subassembly and an associated fastener magazine connected to the housing to present one of a stick of fasteners to the drive path, wherein
the stick of fasteners assists in supporting the fastener along the drive path as the fastener is being driven by the driver.

15. The fastening tool claimed in claim 13, wherein the biasing agent is a single resilient member connected to a fastener guide biasing agent receptacle; and
wherein the driver moves the fastener guide fingers back into their respective slots against the bias of the single resilient member and out of the drive path when the driver drives a “U”-shaped fastener having the second width.

16. The fastening tool claimed in claim 13, wherein, when the driver drives a “U”-shaped fastener having the first width, a portion of one of the fastener guide fingers is configured to remain in contact with a leg of the “U”-shaped fastener having the first width.

17. The fastening tool claimed in claim 16, wherein, when the driver drives a headless nail or a brad, a portion of the other of the fastener guide fingers is configured to remain in contact with the headless nail or brad, respectively.

18. The fastening tool claimed in claim 13, wherein one of the fastener guide fingers sandwiches one of: a leg of the “U”-shaped fastener having the first width, a brad, and a headless pin, against a channel side portion.

19. The fastening tool claimed in claim 13, wherein both fastener guide fingers are configured to guide respective legs of a “U”-shaped fastener having the first width.

20. The fastening tool claimed in claim 18, wherein the fastener guide fingers have different lengths; and
wherein the shorter of the fastener guide fingers is configured to guide one of: a leg of the “U”-shaped fastener having the first width, a brad, and a headless pin.
